(19) United States
(12) Patent Application Publication
(10) Pub. No.: US 2026/0328362 A1
(43) Pub. Date: Oct. 22, 2026

(54) LIGHTING DEVICE FOR VEHICLES

(71) Applicant: HELLA GMBH & CO. KGAA, Lippstadt (DE)

(72) Inventors: Mathias Drüppel, Bad Wünnenberg (DE); David Duhme, Lippetal (DE); Bernd Fischer, Altenbeken (DE); Julian Grote, Borchen (DE); Lukas Hiller, Lippstadt (DE); Marc Kaup, Paderborn (DE); Susanne Köhler, Lippstadt (DE); Christian Schmidt, Paderborn (DE); David Schulz, Dortmund (DE)

(21) Appl. No.: 19/648,302

(22) Filed: Apr. 15, 2026

(30) Foreign Application Priority Data
Apr. 17, 2025 (DE) 102025115171.7
Feb. 5, 2026 (DE) 102025005183.2

(51) Int. Cl. F21S 43/20; F21S 41/143; F21S 41/20; F21S 41/275; F21S 41/29; F21S 43/14; F21S 43/27

(52) U.S. Cl. CPC F21S 43/26241; F21S 41/143; F21S 41/275; F21S 41/2805; F21S 41/29; F21S 43/14; F21S 43/26231; F21S 43/26271; F21S 43/265; F21S 43/27; F21S 43/2817

(57) ABSTRACT

The invention relates to a lighting device for vehicles. The lighting device includes a housing containing a number of light sources for emitting light, optics for deflecting the light according to a predetermined light distribution, and a cover pane closing off an opening in the housing, wherein the optics is designed as an optical film having an optical structure arranged on at least one side thereof.

### CROSS-REFERENCE TO RELATED APPLICATIONS

This application claims the benefit of German Patent Application 10-2025-115-171.7, filed Apr. 17, 2025, and German Patent Application 10-2025-005-183.2, filed Feb. 5, 2026, the disclosures of which are incorporated by reference in their entirety.

### FIELD OF THE INVENTION

The invention relates to a lighting device for vehicles having a housing containing a number of light sources for emitting light, an optics for deflecting the light in accordance with a predetermined light distribution, and a cover pane closing off an opening in the housing.

### BACKGROUND OF THE INVENTION

A lighting device for vehicles is known from DE 10-2020-102-226 A1 that comprises a light source and several optics for preforming light emitted by the light source and subsequently deflecting the preformed light in accordance with a predetermined light distribution. To preform the light, collimation optics are provided that are designed as a lens that collimates the light emitted by the light source. On the light entry side, the collimation optics are fitted with an aperture so that a light transmission window is formed through which the light from the light source can pass. An aperture edge is then mapped by the downstream optics to form a light/dark boundary. The downstream optics are designed as a lens array having a plurality of lens elements distributed over the surface. The lens array optics thus formed has a first lens array on the light entry side and a second lens array on the light exit side, wherein the lens array on the light entry side generates a plurality of intermediate images of the aperture, which are located in an intermediate space between the two lens arrays. Using the lens array on the light exit side, these intermediate images are then imaged into light spots, from which the light distribution is composed. A disadvantage of the known lighting device is that the optics consist of injection-molded plastic lenses or pressed glass lenses, which are manufactured using a complex primary molding process. Due to the manufacturing process, not all desired shapes and structures can be realized. It would be desirable to further reduce the weight of the optics.

DE 10-2019-124-555 A1 discloses a lighting device for vehicles having a light source and optical means, wherein the optical means include, among other things, a hologram element in which diffraction information is stored so that a three-dimensional holographic image is generated in a front field. This allows a three-dimensional light signature to be created to generate a signal light function. A signal light function is advantageously generated here by means of a film. The disadvantage of this, however, is that the manufacturing effort required to insert the diffraction structures is relatively complex, and the light function is limited.

### SUMMARY OF THE INVENTION

The object of the present invention is therefore to further develop a lighting device for vehicles of the type in such a way that a predetermined light distribution, in particular a headlamp light distribution, can be provided in a space-saving manner and with low weight. To achieve this object, embodiments of the invention include optics that are configured as an optical film having an optical structure arranged on at least one side thereof.

The particular advantage of the invention is that by providing an optical film having optical structures on at least one side thereof, the light can be deflected in such a way that a predetermined light distribution or partial light distribution can be produced. The optical structure contained in the film virtually replaces the function of a classic refractive solid body, in particular a lens. In contrast to solid bodies, the optical film according to the invention can be produced as a mass product in a simple process, for example, roll-to-roll. The optical structure consists of a plurality of optical elements distributed over the surface. These optical elements each have refractive properties. The optical elements and thus the optical structure can be calculated in such a way that the optical film is, for example, curved and extends with a parallel offset relative to a cover pane of the lighting device. If the optical film is arranged at a relatively small distance from the cover pane and has a surface area in the region of the cover pane, the interior space of the lighting device can be covered by the optical film. The lighting device therefore has a regular and harmonious appearance.

According to a further development of the invention, the optical structure of the film is produced on a substrate of the film by embossing or by a combination of embossing and simultaneous crosslinking of a resin applied to the substrate. This saves costs. The optical film can be provided on a roll and cut by punching, cutting or laser cutting according to the desired application and/or the size of the illuminated area.

According to a further development of the invention, the optical film has a wall thickness in the range between 100 μm and 800 μm. The optical film is thus relatively thin. As the optical film can be bent, it can be clamped in a bent state around one and/or two different bending axes, so that it has a three-dimensional appearance. Even in the bent state, the optical film has a constant wall thickness over its entire surface. Preferably, the optical film is clamped without stretching so that the optical structure or the optical elements have the predefined relative position with regard to a base surface of the substrate in the installation position.

According to a further development of the invention, the optical structure of the optical film has a plurality of prism-shaped or cylindrical protrusions that protrude from a plane of a substrate of the optical film. These protrusions serve as a refractive surface for the light beams and are shaped and/or arranged relative to each other in such a way that the light exiting from the optical film has the specified light distribution or partial light distribution.

According to a further development of the invention, the protrusions of the optical structure are shaped and/or distributed over the substrate in such a way that they refract the light impinging on the film in the manner of a Fresnel lens. The optical film thus serves as a replacement for a conventional Fresnel lens made of a glass or plastic material.

According to a further embodiment of the invention, the optical film is attached to a support device that has receiving portions for receiving the optical film at least at opposite edges of the optical film. The distance between the receiving portions is smaller than the extent between the edges of the optical film clamped to the receiving portions. In this way, a bent arrangement of the optical film is realized around a bending axis running between the receiving portions. The optical film thus does not extend in one plane, but rather is designed to be curved, wherein the wall thickness is always constant, in particular constant and/or unchanged irrespective of the curved or planar state. The optical film preferably has an inherent rigidity so that it has a defined curved shape when it is received by the support device without stretching.

According to a further development of the invention, the optical film is arranged in such a way that it extends in a shape adapted to the cover pane. In particular, it can be arranged at a parallel distance from the cover pane. It can thus have the same shape as the cover pane. The dimension of the optical film is in this case equal to or smaller than the dimension of the cover pane. This has the advantage of completely covering the light source and, where applicable, any other optical elements. This allows a homogeneous appearance of the lighting device to be created.

According to a further development of the invention, a first optical film having a plurality of optical elements and a second optical film having a plurality of optical elements are provided. The optical elements of the first optical film are designed or arranged in such a way that the light is scattered in a first direction. The optical elements of the second optical film are arranged or designed in such a way that the light is scattered in a direction perpendicular to the first direction. Advantageously, the first optical film can be used to deflect or scatter light in a horizontal direction, and the second optical film can be used to deflect or scatter light in a vertical direction. The advantage of this is that a predetermined light distribution of a headlamp, for example a low beam distribution, can thus be generated. In this case, one edge of the light source, which is preferably designed as an LED light source, can serve as an aperture edge that is imaged to form a light/dark boundary of the light distribution.

According to a further development of the invention, a collimator is provided between the first optical film and the second optical film on one side and the light source on the other side, by means of which the light emitted by the light source is collimated. In this way, the light impinges in parallel on the first optical film, at which the light is deflected in the first direction.

According to a further development of the invention, the first optical film has cylindrical protrusions as an optical structure only on one side, so that the light in the first direction is deflected or scattered in the first direction. If the first direction corresponds to the horizontal direction, the light is scattered according to a predefined illuminated width of the light distribution.

According to a further development of the invention, the second optical film has freeform protrusions on both sides, by means of which the entering light is deflected in the second direction at different angles in such a way that the light is deflected to form light strips of different lengths. The freeform protrusions are shaped in such a way that a boundary ray of the respective light beams emitted by the protrusions is emitted at such an angle that the light/dark boundary of the light distribution is thus formed. The superimposition of the light beams deflected by the respective protrusions forms the predefined light distribution. The light distribution is thus formed from a plurality of light strips extending in a vertical direction and having different angles, wherein the light strips are each created by light beams having different or identical angular ranges. Advantageously, a headlamp function can thus be created in a space-and weight-saving manner.

According to a further development of the invention, the optical protrusions of the optical film have a preferred direction. The protrusions are therefore designed to be elongated in the preferred direction. The protrusions are offset parallel to each other, wherein the shape of adjacent protrusions is preferably different.

### BRIEF DESCRIPTION OF THE DRAWINGS

Exemplary embodiments of the invention are explained in more detail below with reference to the drawings. In the drawings:

FIG. 1 is a schematic side view of a lighting device according to a first embodiment;

FIG. 2 is a front view of the lighting device according to FIG. 1;

FIG. 3 is a side view of a lighting device according to a second embodiment;

FIG. 4 is a section along line IV-IV in FIG. 3; and

FIG. 5 is an enlarged side view of a single unit X in FIG. 3.

### DETAILED DESCRIPTION

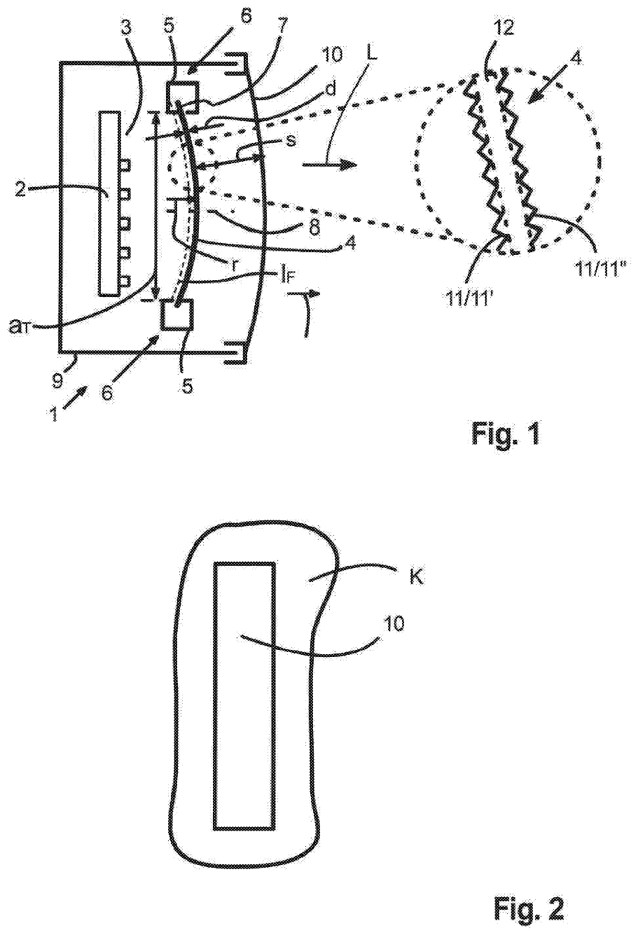

A lighting device 1 according to FIG. 1 and FIG. 2 is used to generate a signal light function, for example, a brake/tail light function, a cornering light function, and a daytime running light function. The lighting device 1 can be arranged in the front or rear region of the vehicle.

The lighting device 1 has a printed circuit board 2 on which a plurality of light sources 3 are arranged. The light sources 3 are designed as LED light sources or LED chips. The light sources 3 emit light L in the main beam direction H of the lighting device 1. In the main beam direction H in front of the light sources 3 that are preferably arranged in a matrix-like manner on the rectangular printed circuit board 2, an optical film 4 is arranged as an optics, which is clamped on opposite sides in receiving portions 5 of a support device 6. For this purpose, opposite edges 7 of the optical film 4 each engage into the receiving portions 5 and are held therein in a force-fit and/or form-fit manner. For example, the opposing edges 7 can be connected to the receiving portions 5 by clamping.

In the present exemplary embodiment, the optical film 4 does not extend flat, but rather is curved around a bending axis 8 extending between the edges 7. In this way, the optical film 4 is arranged slightly curved in the main beam direction H. A distance aT between the opposite receiving portions 5 is smaller than an extent lF of the optical film 4 between opposite fastened edges 7 thereof. A rigidity of the optical film 4 promotes this curved mounting position.

For example, the optical film 4 can be designed to be curved in the same direction as a cover pane 10 covering an opening of a housing 9 of the lighting device 1. The optical film 4 can thus have the same curvature over the surface as the cover pane 10. The optical film 4 can, for example, extend at a constant parallel distance s from the cover pane 10. It therefore has a shape adapted to the cover pane 10. The optical film 4 can have a surface area that is equal to or smaller than the surface area of the cover pane 10. The cover pane 10 preferably extends flush with the vehicle body K of the vehicle.

The optical film 4 has an optical structure consisting of a plurality of protrusions 11. In the exemplary embodiment according to FIG. 1 and FIG. 2, protrusions 11 are designed as prism-shaped protrusions that rise from a plane of a substrate 12 of the optical film 4. The prism-shaped protrusions 11 extend, for example, in a continuous strip from a first edge to an opposite edge of the optical film 4. They can be designed to be, for example, triangular in cross section.

In the present exemplary embodiment, prism-shaped protrusions 11′ extend on the light entry side in the horizontal direction, while prism-shaped protrusions 11″ extend on the light exit side and run in the vertical direction, i.e., perpendicular to the protrusions 11′ on the light entry side. In this way, scattering in two directions arranged perpendicular to each other is generated to produce a signal light function, for example, a tail light function.

A plurality of light sources 3 can be distributed, preferably uniformly distributed or regularly arranged, on the rectangular printed circuit board 2.

In the present exemplary embodiment, the optical film 4 has a wall thickness d that lies in a range between 100 μm and 800 μm. The protrusions 11, 11′, 11″ can be designed as microlenses that rise from the substrate 12 in a range from 10 μm to 50 μm.

In this exemplary embodiment, the optical film 4 has a bending radius r that lies in the range of 10 mm. Preferably, the bending radius r is in a range greater than 10 mm. Alternatively, the optical film 4 can also be clamped flat to the support device 6 so that the calculation of the shape of the protrusions 11, 11′, 11″ can be simplified.

According to an alternative embodiment of the invention that is not shown, the protrusions 11 can also be formed in such a way that the optical film 4 has the shape and/or the function of a Fresnel lens on one side.

Alternatively, the protrusions 11 of the optical film 4 can also be cylindrical or partially cylindrical or have a different shape.

The optical structure, i.e., the optical protrusions 11, is preferably produced by embossing or by combined embossing with simultaneous cross-linking of a resin applied to the substrate 12.

The substrate can be made, for example, of PC, PET, or another polymer.

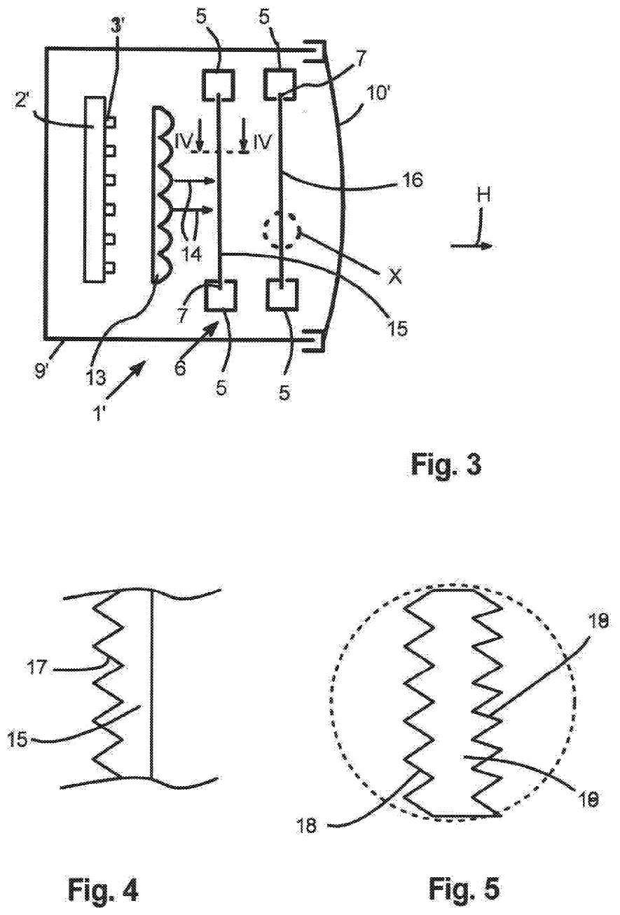

According to a further exemplary embodiment of the invention according to FIGS. 3 to 5, a lighting device 1′ is provided that serves as a headlamp.

The lighting device 1′ has a printed circuit board 2′ on which a plurality of light sources 3′ are arranged. The light sources 3′ are designed as LED light sources or LED chips. They are uniformly distributed over one side of the printed circuit board 2′.

A number of collimators 13 are arranged in front of the light sources 3′ in the main beam direction H, each of which is formed as a lens made of a plastic and/or glass material and is shaped like a lens in such a way that the light 14 emitted by the light sources 3′ is collimated.

A first optical film 15 and a second optical film 16 are arranged in front of the collimators 13 arranged next to one another in the main beam direction H.

The first optical film 15 has a plurality of optical elements 17 on a light entry side that are designed in such a way that the light 14 is deflected in a first direction, in the installed position of the lighting device 1′ in a horizontal direction, in accordance with a predetermined angular range. The optical elements 17 can be designed, for example, as prism-shaped protrusions. The first optical film 15 has no optical elements on the light exit side.

Alternatively, the first optical film 15 can also have cylindrical protrusions as optical elements 17.

The second optical film 16 has freeform optical elements 18, 19 on both sides. The optical elements 18 on the light entry side and the optical elements 19 on the light exit side can be designed to match each other in pairs. The light-entry-side optical elements 18 can be designed as facets in a light-entry-side facet array, and the light-exit-side optical elements 19 can be designed as facets of a light-exit-side facet array. In the installed position of the lighting device 1′, the light-entry-side facets 18 and the light-exit-side facets 19 extend in a straight line in the horizontal direction so that the light is spread or scattered in a direction perpendicular to the first direction, i.e., in the vertical direction.

In the present exemplary embodiment, the light-entry-side facets 18 and/or the light-exit-side facets 19 are designed to be triangular or wedge-shaped in cross section and have a raised surface of 0.03 mm to 0.6 mm relative to a base plane of the substrate 12. The light-entry-side facets 18 are shaped in such a way that the entering light is collected in a region between the respective light-entry-side facets 18 and the light-exit-side facets 19 arranged behind them in the main beam direction H of the pairs of facets thus formed, preferably in the center between the first light-entry-side facets 18 and light-exit-side facets 19 of the respective pair of facets. A focal point of the light-entry-side facets 18 thus lies in a region between the light-entry-side facets 18 and light-exit-side facets 19 of the same pair of facets. The pairs of facets are arranged next to each other and extend in different horizontal planes.

The light-exit-side facets 19 of the respective facet pairs are designed in such a way that an imaginary parallel light ray entering the light-exit-side facet 19 against the main beam direction H is collected in a plane in which the light-entry-side facet 18 of the same facet pair is located. The focal point of the light-exit-side facet 19 thus lies in the vertical plane of the light-entry-side facet 18 of the same pair of facets.

The light-entry-side facets 18 are regularly distributed over a surface and/or a plane. They preferably have the same shape and/or size.

The light-exit-facets 19 are regularly distributed over a surface and/or plane that extends parallel to the surface and/or plane of the light-entry-side facets 18. They preferably do not have the same size, but rather have such a shape and/or size that they deflect the light coming from the light-entry-side facets 18 into light spots to form a symmetrical light distribution.

The light-exit facets 19 preferably have the same length in the direction in which they extend. They differ in cross section. The different contours in the cross section lead to different vertical light beam angles.

Each light-exit-side facet 19 deflects the light 14 into a light beam in a predetermined angular range. The angular range of different light-exit-side facets 19 can be different or the same. Common to all the light emitted by the light-exit-side facets 19 is that an upper boundary ray of the respective light beams forms a common light/dark boundary of the light distribution. Superimposing the light strips creates a light distribution having an increased illuminance in a central region and a reduced illuminance in the edge region. In this way, for example, a symmetrical light distribution (low beam) can be generated.

The light-entry-side facets 18 and the light-exit-side facets 19 (optical elements) each extend in a preferred direction that in the present embodiment runs in a horizontal direction. They are designed to be elongated.

Preferably, the optical elements 17, 18, 19 extend with a width and/or a height in the mm range or μm range.

The components of the lighting device 1′, namely the light sources 3′, the collimators 13, the first optical film 15, and the second optical film 16, are arranged in a housing 9′ of the lighting device 1′, the opening of which is closed by a cover pane 10′. The cover pane 10′ is designed to be transparent and/or crystal clear.

The first optical film 15 and the second optical film 16 are clamped and/or fastened in a support device 6 that is not shown, like the optical film 4 according to the first exemplary embodiment. In the present exemplary embodiment, the first optical film 15 and the second optical film 16 extend at a distance from each other and in each case flat or perpendicular to the main beam direction H of the lighting device 1′. The first optical film 15 and the second optical film 16 extend parallel to each other.

The first optical film 15 can be arranged in front of or behind the second optical film 16 in the main beam direction H.

### LIST OF REFERENCE SYMBOLS

1, 1′ lighting device
2, 2′ printed circuit board
3, 3′ light sources
4 optical film
5 receiving portions
6 support device
7 edges
8 bending axis
9, 9′ housing
10,10′ cover pane
11, 11′, 11″ protrusions
12 substrate
13 collimation
14 light
15 first optical film
16 second optical film
17 optical elements
18 optical elements/facets
19 optical elements/facets
L light
H main beam direction
a_{T} distance
l_{F} extent
s distance
d wall thickness
r bending radius

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A lighting device for a vehicle comprising:
a housing containing a plurality of light sources configured to emit light;
optics configured to deflect the light according to a predetermined light distribution; and
a cover pane closing an opening in the housing, wherein the optics comprises an optical film having an optical structure arranged on at least one side, wherein a first optical film includes a plurality of optical elements configured to scatter light in a first direction, and wherein a second optical film is disposed upstream in a main beam direction and includes a plurality of optical elements configured to scatter light in a second direction perpendicular to the first direction.

2. The lighting device of claim 1, wherein the optical film has a wall thickness in a range between 100 micrometers and 800 micrometers.

3. The lighting device of claim 1, further comprising a collimator disposed between the first optical film and the light sources and configured to collimate the light of the light sources.

4. The lighting device of claim 1, wherein the first optical film has the optical elements only on a single side, and the optical elements comprise cylindrical protrusions configured to scatter entering light in the first direction.

5. The lighting device of claim 1, wherein the second optical film has freeform optical elements on both sides configured to deflect entering light in the second direction at different angular ranges such that light beams with different beam angles are formed into light strips of different lengths forming the light distribution, and wherein an upper boundary ray of the light beams is emitted at an angle forming a light/dark boundary of the light distribution.

6. The lighting device of claim 1, wherein the optical film and a printed circuit board carrying the light sources are elongated.

7. The lighting device of claim 1, wherein the optical elements have a preferred direction and extend along the preferred direction from one edge to an opposite edge of the optical film.

8. The lighting device of claim 1, wherein the optical elements have a width and/or height in a millimeter range or in a micrometer range.

9. A lighting device for a vehicle comprising:
a housing containing a plurality of light sources configured to emit light;
optics configured to deflect the light according to a predetermined light distribution; and
a cover pane closing an opening in the housing, wherein the optics comprises an optical film having an optical structure arranged on at least one side, wherein optical elements are shaped and/or arranged over a substrate of the optical film such that the optical elements refract light impinging on the optical film in accordance with a Fresnel lens.

10. The lighting device of claim 9, wherein the optical film has a wall thickness in a range between 100 micrometers and 800 micrometers.

11. The lighting device of claim 9, wherein the optical film has a bending radius of at least 10 millimeters.

12. The lighting device of claim 9, wherein the optical structure comprises a plurality of prism-shaped or cylindrical optical elements projecting from a plane of the substrate.

13. The lighting device of claim 9, wherein the optical film is fastened to a support device having receiving portions configured to receive the optical film at least at opposite edges, and a distance between the receiving portions is smaller than an extent of the optical film between the opposite edges.

14. The lighting device of claim 9, wherein the optical film is arranged at a distance from the cover pane and has a shape adapted to the cover pane.

15. The lighting device of claim 9, wherein the optical film and a printed circuit board carrying the light sources are elongated.

16. The lighting device of claim 9, wherein the optical elements have a preferred direction and extend along the preferred direction from one edge to an opposite edge of the optical film.

17. The lighting device of claim 9, wherein the optical elements have a width and/or height in a millimeter range or in a micrometer range.
